(19) United States
(12) Patent Application Publication
(10) Pub. No.: US 2007/0226071 A1
(43) Pub. Date: Sep. 27, 2007

(54) System and method for generating work order instructions

(76) Inventors: Peter Kern, Westminster, CO (US); Scott Fowle, Louisville, CO (US); Mike Doe, Thornton, CO (US); Wade Flemmer, Brighton, CO (US); Jeff Block, Westminster, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/389,988

(22) Filed: Mar. 27, 2006

(51) Int. Cl. G06Q 30/00

(52) U.S. Cl. 705/26

(57) ABSTRACT

A system and method for generating a work order instructions is described. In one embodiment an order from a customer is received, which includes information for a desired end product and the information is converted into machine-readable work order instructions, which includes instructions to alter goods in accordance with the desired end product. In addition, the machine readable work order instructions are sent via a network to a value-adding business and loaded into a machine at the value-adding business, which is configured to alter the goods in accordance with the instructions for altering the goods.

### PRIORITY

This application is a continuation-in-part of application Ser. No. ______ entitled System and Method for Facilitating Value-Adding Businesses filed on Jan. 30, 2006, which claims priority to provisional application No. 60/742,475 filed on Dec. 5, 2005, entitled Business System and Method, all of which are incorporated herein by reference.

### FIELD OF THE INVENTION

The present invention relates to systems and methods for enhancing unfinished goods. In particular, but not by way of limitation, the present invention relates to systems and methods for enhancing goods in accordance with specific instructions.

### BACKGROUND OF THE INVENTION

In many instances, persons or established businesses possess the skill and knowledge to perform particular value-added operations that render ordinary goods more desirable by altering, adding to or improving the goods. For example, there are many businesses that sell embroidery, printing, engraving or other types of services that perform very well when providing these value-adding type of operations.

Operating a viable business, however, often requires much more than simply providing value-adding services. In particular, there are several “non-value-added” operations such as marketing, sales, purchasing of materials, logistics, finance and information services that many businesses do not have either the resources, skills and/or the desire to become engaged in.

In many instances, for example, the business proprietor may have exceptional skills when rendering particular services (e.g., printing services), but may have no experience, nor any desire, to become experienced in sales, marketing, logistics and finances. In many instances, however, a business simply can not profitably operate without having these non-value-added operations in place.

Moreover, many value-adding businesses manually generate written work order instructions and carry them out by reading details (e.g., textual information) in the instructions and manually performing operations to carry out the work order instructions. This approach, however, is often costly because it requires personnel to read and carry out the work order instructions and is prone to mistakes because the instructions may be improperly read, interpreted and/or effectuated.

Accordingly, a system and method are needed to take care of these non-value-added operations and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In some embodiments, the invention may be characterized as a method for generating a work order including receiving an order, which includes information for a desired end product, converting the information for the desired end product into machine-readable work order instructions, sending the machine readable work order instructions via a network to a value-adding business and loading the work order instructions into a machine at the value-adding business that is configured to alter the goods in accordance with the instructions for altering the goods.

In another embodiment, the invention may be characterized as a machine-readable data construct for ordering work including design data that includes sufficient data to enable a machine configured to read the design data to alter goods so as to effectuate the design, goods data that defines particular goods selected by the end customer that are to be altered in accordance with the design data, graphics data including data representing the design selected by the end customer and design identification data including data that is utilized in connection with initiating execution of the design data by the machine.

In yet another embodiment, the invention may be characterized as a method for enhancing goods including receiving a machine-readable work order file, which identifies at least one enhancement that is to be added to at least one piece of unfinished goods and image data for an image, which depicts a location on the at least one piece of unfinished goods where the at least one enhancement is to be added. In addition, the method in this embodiment includes processing the image data so as to place the image data in a displayable form and displaying the image so as to enable a user to see the location on the at least one piece of unfinished goods where the enhancement is to be added.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a block diagram of one implementation of the present invention;

FIG. 2 is a block diagram of an exemplary business solution system;

FIG. 3 is a flowchart depicting an exemplary business method;

FIG. 4 illustrates an exemplary user interface; and

FIG. 5 is a block diagram of one embodiment of a value-adding business depicted in FIG. 1;

FIG. 6 is a block diagram of another embodiment of a value-adding business depicted in FIG. 1;

FIG. 7 is a flowchart depicting a method in accordance with some embodiments;

FIG. 8 depicts an exemplary embodiment of work order instructions; and

FIG. 9 is a block diagram depicting an exemplary work order processing system.

### DETAILED DESCRIPTION

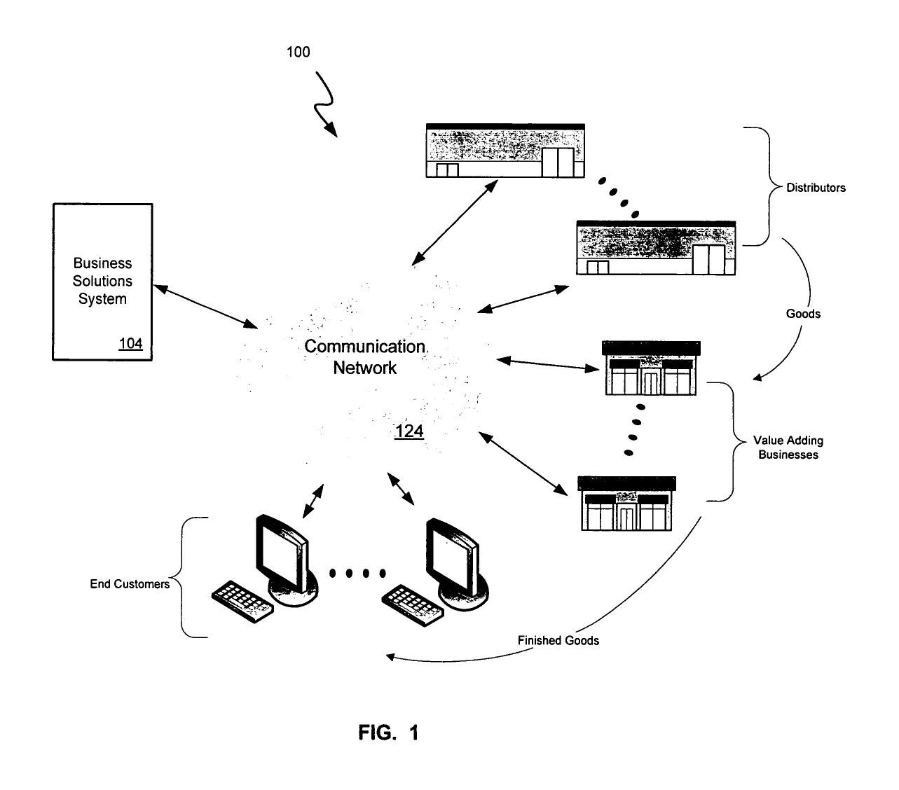

Referring now to the drawings, FIG. 1 depicts an exemplary environment in which several embodiments of the inventive business model may be employed. As shown in FIG. 1, a business solutions system 104 is in communication with distributors, value-adding businesses and end customers. The value-adding businesses in several embodiments are businesses that add value in one or more ways to goods. For example, the value-adding businesses may be screen printing businesses, embroidery businesses, engraving businesses, carving businesses, printing businesses, painting businesses or any other business that adds value to goods.

The distributors depicted in FIG. 1 are providers of goods, which may include, without limitation, clothing, wood, ceramics, paper, fabrics, metal as well as any other goods that may be operated on by the value-adding businesses. The distributors may create and sell the goods or simply buy and sell the goods. In many instances the distributors are wholesale distributors, but this is certainly not required.

The end customers depicted in FIG. 1 are people or business entities that desire finished goods from the value-adding businesses. As depicted in FIG. 1, the end customers have access to network enabled devices (e.g., computers, PDAS, telephone handsets), which enable the end users to communicate via the network 124 (e.g., the Internet) to the business solution system 104.

The business solution system 104 in the exemplary embodiment enables several aspects of the inventive business model. In particular, the business solution system 104 in several embodiments provides several “non-value-added” operations for the value-adding businesses such as marketing, sales, purchasing of materials, logistics, finance, MIS, etc. In return for providing these non-value-added operations, a controller of the business solution system 104 realizes revenue based upon a subscription-based and/or transaction-based fee structure. It should be recognized that the business solution system 104 is depicted in FIG. 1 as a single component merely for purposes of clarity, and that the business solution system 104 may be realized by a collection of discrete components that may be distributed over one or more physical locations.

In many embodiments, the business solution system 104 provides the value-adding businesses with a combination of one or more of the following operations:
A wizard to conveniently setup and customize a home page, billing schemes/rules, tax rates, financial services (means for payment, such as credit cards, PayPal, etc.), accounts with shipping companies and material suppliers.
Marketing operations including a search-engine-optimized home page; a feeder site to direct traffic to the businesses; customer contacts; means for advertisement as well as means for communication.
Sales operations including a customizable ecommerce storefront, allowing the businesses to present a wide variety of goods and services in a variety of languages. End-customers in many embodiments are able to order goods/services based on customized pricing scheme.
Purchasing of materials: as end-customers order through the ecommerce storefront, in some variations the system automatically places an order with the distributor(s) for the needed materials
Logistic services: through a integration with one or more shipping companies, the businesses are able track the shipment of goods from the distributor(s). Furthermore, it allows the businesses to use the shipping services for shipments of its finished (value-added goods) to the end-customer (incl. providing tracking numbers on the web).
Financial services: the system in several embodiments automatically takes care of collecting money from the end-customer, paying the distributors(s), creating invoices, generating reports for taxes, etc.
Production order requirements: in some variations the system provides specific production order requirements to each value-adding business. The production order requirements include information, which assists the value-adding businesses to effectuate the finishing of unfinished goods. In the context of a value-adding business that performs embroidery services, for example, the production order requirements. in one embodiment, include frame definition (e.g., the size and shape of the embroidery frame that should be utilized), statistics (e.g., a specific location for design placement relative to a portion of the unfinished good (e.g., relative to collar of a shirt) and design characteristics (e.g., color and type of thread to be utilized).
MIS: in many implementations the system hosts storage and processing of a wide variety of data, such as customer/distributor orders, order status, and provides data backup for customer.
Production scheduling: the system in several variations schedules the next job in order of priority (including an expedite option), and line up the materials with the order.
Online help and customer service: an online assistance organization in many embodiments is provided as well as an email delivery system for confirming receipt of order and receipt of payment.
In some variations, the system also enhances marketing for the end customers by coordinating mass mailing of marketing materials (e.g., via email or standard mail).

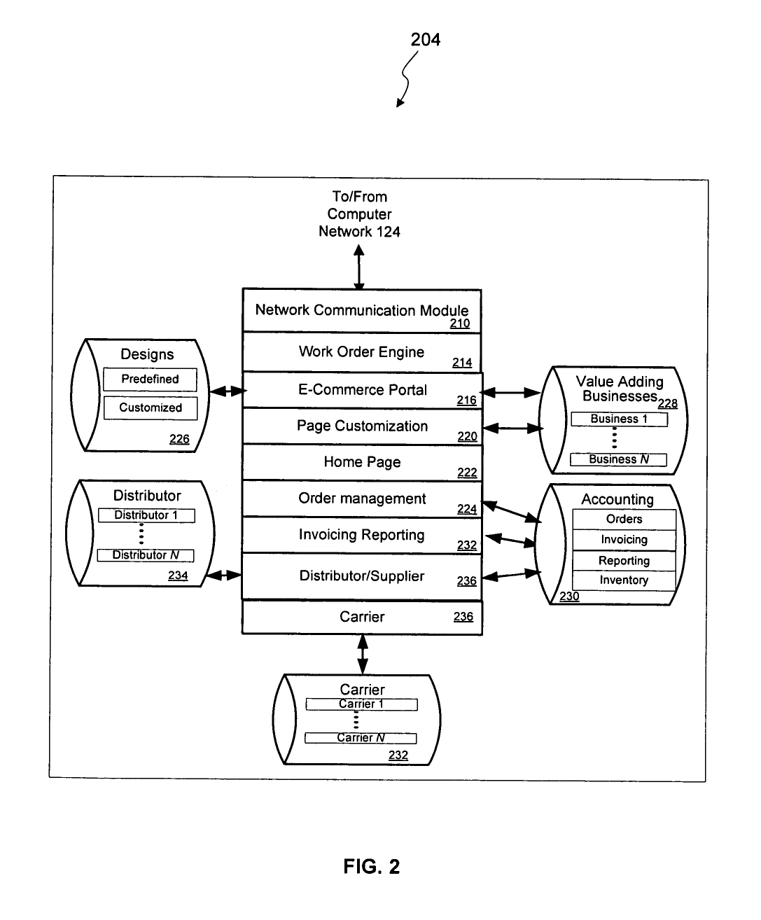

Referring next to FIG. 2, shown is an exemplary embodiment of a business solution system 204, which may be employed as the business solution system 104 depicted in FIG. 1. As depicted in FIG. 2, the system 204 includes a network communication module 210, a work order engine 214, an ecommerce portal 216, a page customization module 220, a home page module 222, an order management module 224, an invoicing and reporting module 232 a distributor module 236 and a carrier module 236. In several embodiments these modules are realized by software executed by one or more processors, but this is not required, and in other variations the modules may be realized by hardware or a combination of hardware and software. It should be recognized that the modules are shown as separate modules merely to depict the various functional aspects of the system 204 and that those of ordinary skill, having benefit of this disclosure, will appreciate that some of the modules may be combined together. It should also be recognized that the modules certainly need not be located in one physical location and that a controller of the system 204 may outsource some of the functions to third parties. Moreover, this embodiment is merely exemplary and in other embodiments one or more of the modules are omitted from the system 204.

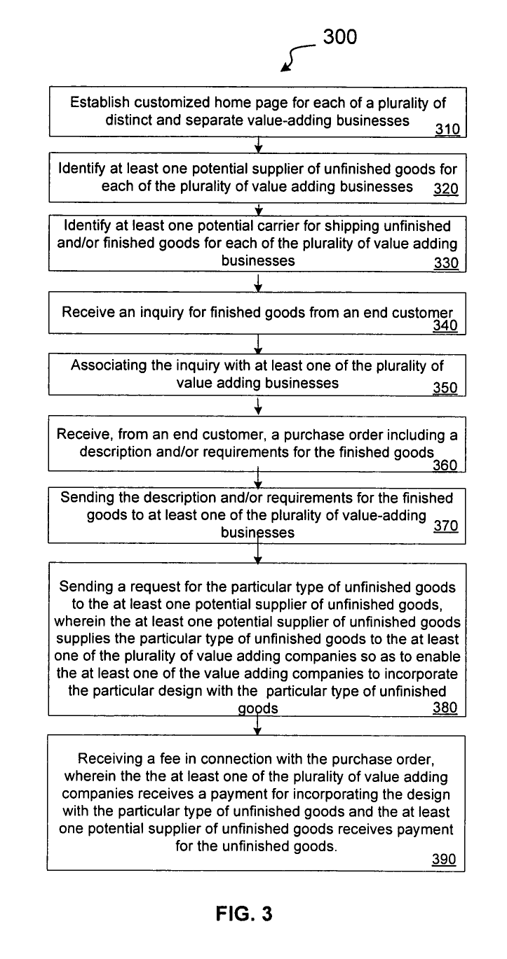

Also depicted in FIG. 2 are a design database 226, a value-adding businesses database 228, an accounting database 230, a carrier database 232 and a distributor database 230. As shown in FIG. 3, the design database 226 includes both predefined and customized designs that are selectable by the end customers when ordering finished goods. The customized designs include designs customized by one or more of the businesses, which are organized so as to be retrievable by an end user when accessing a particular business' home page via the ecommerce portal 216.

In this embodiment, the value-adding companies database 228 includes information about each of the businesses including data defining a customized home page for each of the businesses, products and services offered by the businesses and associated pricing established by each of the businesses.

The accounting database 230 in the exemplary embodiment includes information about each order placed by end customers, information to prepare invoices, information enabling reports to be generated (e.g., for tax purposes) and inventory information.

The carrier database 232 includes information (e.g., pricing) about carriers that are available to ship unfinished goods from distributors to the value-adding companies and finished goods from the value-adding companies to the end customers. Similarly, the distributor database 234 in this embodiment includes information about each of the distributors, the goods provided by each distributor and the pricing of the goods.

While referring to FIG. 2, simultaneous reference will be made to FIG. 3, which is a flowchart 300 depicting an exemplary business method, which may be carried out in connection with the systems 104, 204 depicted in FIGS. 1 and 2. Although the method depicted in FIG. 3 is described with reference to FIG. 1 and/or FIG. 2, it should be recognized that the method is certainly not limited to the specific embodiment depicted in FIGS. 1 and 2.

As shown in this embodiment, each business is able to create a customized home page using the page customization module 220 (Block 310). For example, each business is able to establish not only the look and feel of their home page but also billing schemes/rules, tax rates, financial services including payment arrangements (e.g., credit cards, PayPal, etc.). In addition, each value-adding business is able to identify any accounts that they have with shipping companies and material suppliers.

As shown in FIGS. 2 and 3, the distributor module 236 in connection with the distributor database 234 assist the value-adding businesses with identifying potential suppliers of goods (Block 320), and in many instances these components enable the value-adding businesses to obtain better pricing from the distributors. Similarly, the carrier module 236 in connection with the carrier database 232 enable the value-adding businesses to identify potential carriers of both unfinished and finished goods.

As depicted in FIG. 3, in accordance with the exemplary business method, an inquiry from an end customer is received (e.g., via home page 222 of the system 204) (Block 340), and in response, one or more links to home pages of one or more of the value-added businesses are provided to the end customer (Block 350). The end customer is then able to generate, using a customized homepage for one of the value-adding businesses, a purchase order, which includes a description and/or requirements for finished goods (Block 360).

In accordance with several embodiments, the ecommerce portal 216 enables the end customer to select either a predefined design from the design database 226 or submit their own customized design to be used in connection with goods also selected by the end user. As depicted in FIG. 2, the order management module 224 processes the order from the end user and stores information for the order in the accounting database 230.

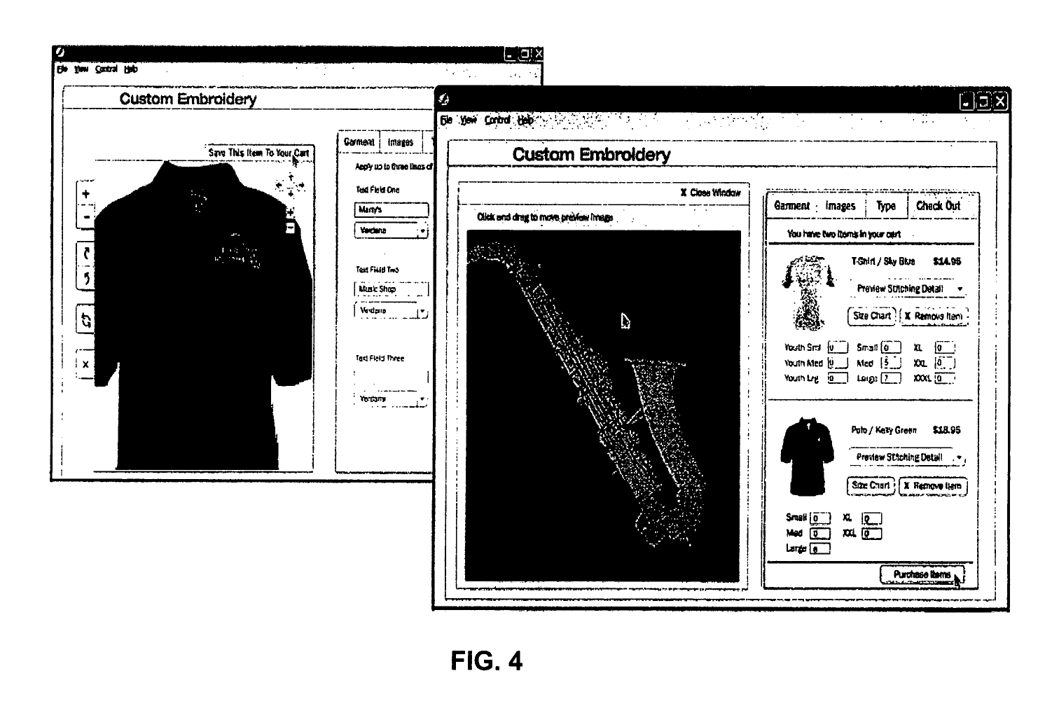

Referring briefly to FIG. 4, shown is a an exemplary user interface such as may by utilized by a value-adding embroidery business. In the embodiment depicted in FIG. 2, the ecommerce portal 216 generates the user interface in connection with previously generated data (e.g., from the value-adding business database 228) that defines the interface. As shown, the exemplary interface lets an end customer select a particular design, and then view a depiction of the finished goods embodying the particular design. In the specific example, an end customer has selected a saxophone design, which is shown embodied as part of a shirt. As depicted in FIG. 4, the exemplary interface enables the end customer to select a type, color, size and quantity of the particular good used in connection with the design.

Advantageously, in several variations the user interface provides a realistic rendering of the goods as adapted with the user-selected design. In this way, the end customer is able to make informed buying decisions and is much less likely to be surprised when they receive the finished product.

Referring again to FIG. 3, once the end customer has completed their purchase order, the description and/or requirements are sent to the value-adding business (Block 370). In many embodiments, the system 204 sends the description and/or requirements to the value-adding business via email, but this is certainly not required, and in other embodiments, the description and/or requirements may be pulled from the system 204 by the value-adding business.

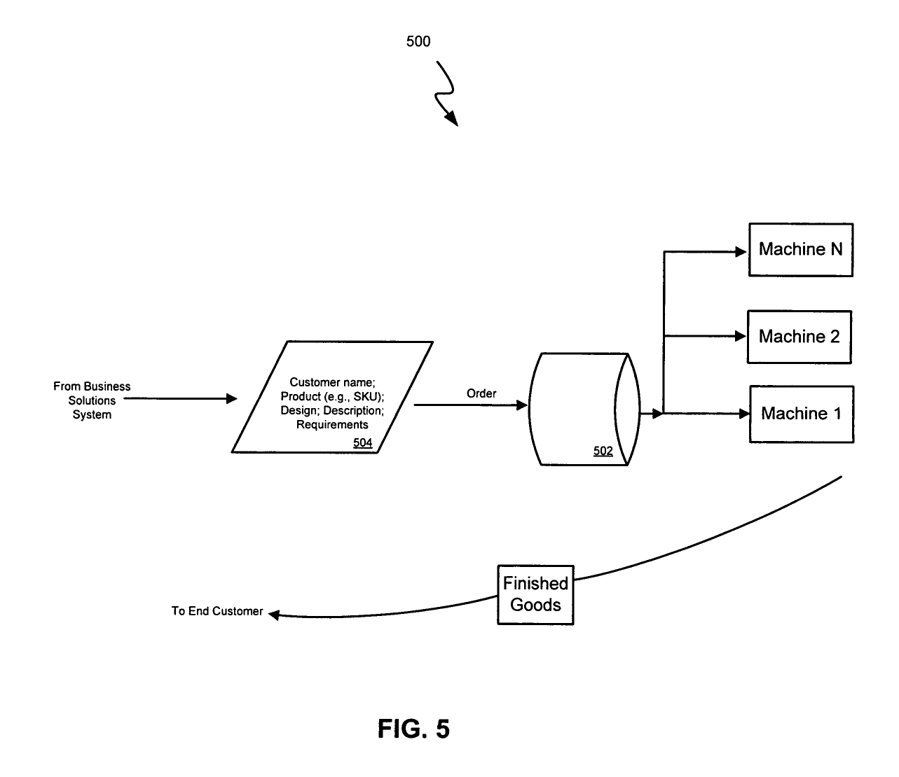

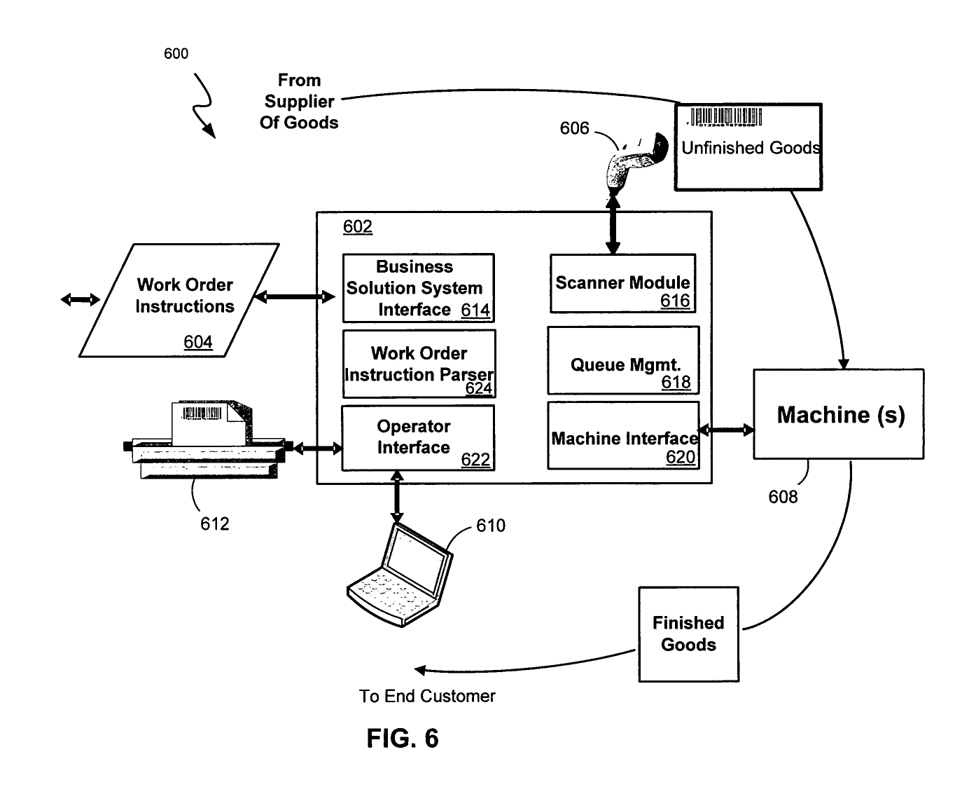

In some embodiments, as discussed further with reference to FIGS. 5 and 6, the work order engine 214 generates a machine readable set of work order instructions and an identifier for the work order instructions. In these embodiments, the work order instructions are read and executed by equipment at the value adding businesses and the identifying information (e.g., bar code data) is utilized in connection with identifying the work order instructions.

In addition, a request for a quantity of unfinished goods (based upon the description and/or requirements in the purchase order) is sent to one or more of the distributors (Block 380). The request in many embodiments includes information about the value-adding business that is to receive the goods as well as information about the carrier preferred/required by the value-adding business. As a consequence the value-adding business receives both the description and/or requirements from the system 204 and the corresponding goods from one or more of the distributors without having to manage marketing, sales, or logistical operations.

In some embodiments (e.g., embodiments described with reference to FIGS. 5 and 6), the work order engine 214 sends the request for a quantity of good along with identifying information (e.g., bar code data), which identifies the work order instructions that are sent to a value adding business. In this way, the distributor may affix the identifying information to the unfinished goods so that the value adding business is able to associate the received goods with the work order instructions. In some embodiments, for example, the identifying information is encoded in bar code data so that the value adding business need only to scan the bar code data with a bar code scanner in order to retrieve the work order instructions.

Once the unfinished goods are received, the value-adding business adapts the unfinished goods in accordance with the description and/or requirements to create finished goods, which are then sent to the end customer. Advantageously, the value-adding business receives payment via the system 204, and information associated with each transaction is stored by the system 204 in the accounting database 230. In this way, the value-adding business is relieved of many of the onerous and/or time consuming operations associated with tracking receivables and accounting.

Although certainly not required, in some embodiments, the unfinished goods are adapted utilizing equipment that is capable of reading and executing machine readable work order instructions generated by the work order engine 214. As discussed further herein with reference to FIGS. 5 and 6, the value adding businesses may receive machine readable work order instructions, which are retrieved and executed when the unfinished goods arrive.

In accordance with several embodiments, a controller of the system 104, 204 receives a fee in connection with the purchase order. As a consequence, the value-adding businesses receive many non-value-adding operations from the system 104, 204 and a controller of the system receives a fee in return. In some variations, the system 104, 204 offers varying subscription levels to each of the value-adding businesses and receives either one-time or ongoing subscription revenues instead of, or in addition to, the transaction based fees.

The different subscription levels may offer varying levels of service relative to one or more of the operations provided by the system 104, 204 including, for example, different levels of marketing, accounting and page customization.

Referring next to FIG. 5, depicted is a block diagram of one embodiment of a value-adding business depicted in FIG. 1. As shown, in this embodiment the value adding business 500 includes a server 502 that is coupled to N (e.g., one or more) machines and is configured to receive a data file 504, which includes information for altering unfinished goods with the N machines.

The N machines in some embodiments are embroidery machines, in other embodiments the N machines are digitals printers, and in yet other embodiments the N machines are screen printing machines. In other variations it is contemplated that the N machines may be any other type of machine that is capable of receiving data and finishing goods in accordance with the data.

The server 502 in one embodiment is a general purpose computer that is adapted with software to operate as a server for receiving data files (e.g., the data file 504), queuing the data files and sending corresponding data to each of the N machines, which in general, informs the N machines what to do and how to do it.

In many embodiments for example, the data file 504 includes information defining both design and production order requirements, and may be organized in a variety of ways including dst, exp and other file organization schemes. The design information includes data that identifies the specific expression of an idea or concept (e.g., textual or graphical ideas/concepts), and the production order requirements include data that defines how to create a physical embodiment of the design.

In the context of embroidery production order requirements, for example, (i.e., where the N machines include embroidery machines), in one embodiment, the data file includes information that defines the type (e.g., square, circular, triangular, etc.) and size of the embroidery frame to be utilized, statistics that include location(s) on the unfinished product where the design is to be implemented and design characteristics (e.g., color and type of thread) to utilize.

In operation, the server 502 is configured to receive the data file 504 and place the data file 504 in a queue among of other data files that are awaiting to be processed. In connection with each received data file, the server 502 sends data to one or more of the N machines that enables the N machines to carry out production order requirements for each corresponding design. In the embodiments where the data file 504 includes production order requirements, the server 502 relays the production order requirements to each of the N machines, and in embodiments where the data file 504 does not include production requirements, production requirements are added at the server 502 and sent to each of the N machines. Additional details related to effectuating operation of multiple stitching machines in accordance with design and requirements data are found in U.S. Pat. No. 6,729,255, filed May 4, 2004, entitled: Synchronizing Independent Stitching Machines, U.S. Pat. No. 6,983,192, filed May 3, 2004, entitled: Computerized Stitching Including Embroidering and U.S. Pat. No. 6,871,605, filed Apr. 28, 2004, entitled: Computerized Stitching Including Embroidering which are incorporated herein by reference.

In some embodiments, the server 502 is made available to value-adding businesses that subscribe to a particular level of service provided by the business solutions system 100. In yet other variations, the server 502 is configured to be capable of being customized by each the value-adding businesses.

Referring next to FIG. 6, shown is another embodiment of a value-adding business depicted in FIG. 1. As shown, in this embodiment the value adding business 600 includes a server 602 that is disposed to receive work order instructions 604 and is coupled to a scanner 606 one or more machines 608, a user interface 610 and a printer 612 and is configured to receive a data file 504, which includes information for altering unfinished goods with the machine(s) 608.

As depicted, the server 602 in this embodiment includes a business solution system interface 614 disposed to receive the work order instructions 604, a scanner module 616 coupled to the scanner 606, a queue management module 618, a machine interface 620 coupled to the machine(s) 608, an operator interface module 622 coupled to both the user interface 610 and the printer 612 and a work order parser 624.

In several embodiments the server components are realized by software executed by one or more processors, but this is not required, and in other variations the modules may be realized by hardware or a combination of hardware and software. It should be recognized that the illustrated arrangement of these components is logical and not meant to be an actual hardware diagram. Thus, the components can be combined or further separated in an actual implementation.

The machine(s) 608 in some embodiments are embroidery machines, in other embodiments the machine(s) 608 are digitals printers, and in yet other embodiments the machine(s) 608 are screen printing machines. In other variations it is contemplated that the machine(s) 608 may be any other type of machine that is capable of receiving data and finishing goods in accordance with the data. Additional details relative to finishing goods in accordance with machine readable data are included in the above-identified and commonly owned U.S. Pat. Nos. 6,729,255, 6,983,192 and 6,871,605 which are incorporated herein by reference

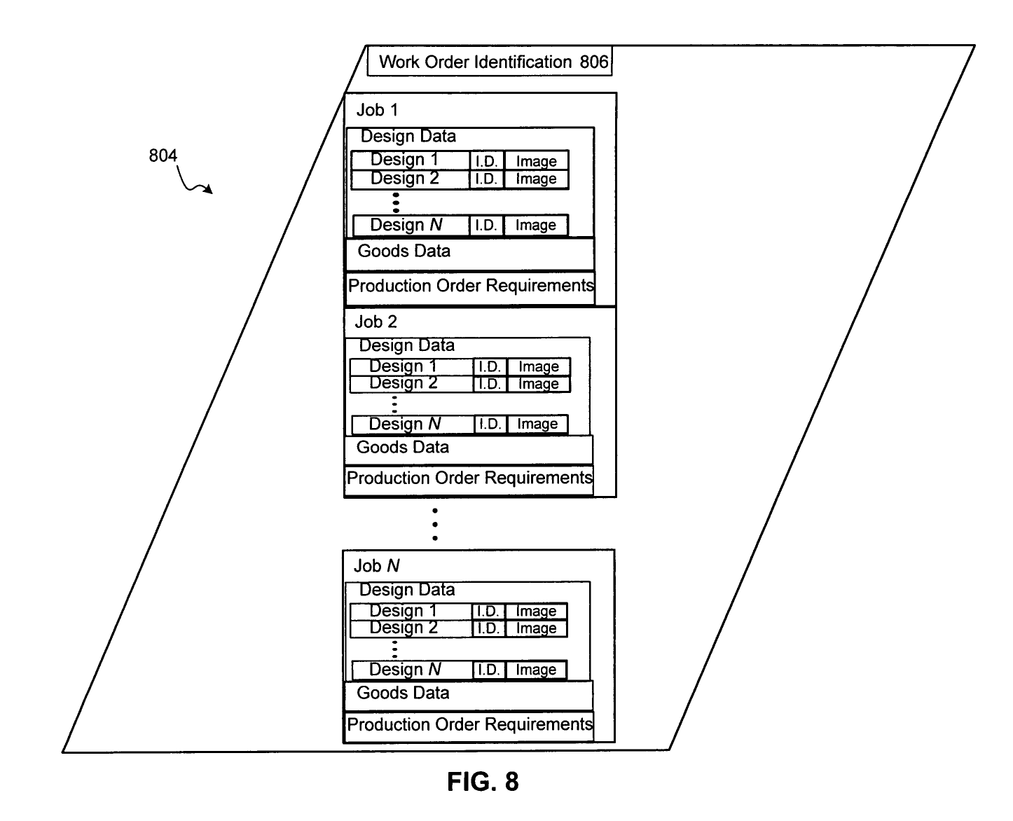

In the exemplary embodiment depicted in FIG. 6, the work order instructions 604 are machine readable work order instructions, which include identifying information to identify the work order instructions 604 from among other work order instructions. In some embodiments (e.g., as described further with reference to FIG. 8), the identifying information is encoded in the form of bar code data, but this is certainly not required.

In several embodiments, the work order instructions 604 include much of the same information as the data file 504 describe with reference to FIG. 5. In many embodiments, for example, the work order instructions 604 include information defining both design and production order requirements, and may be organized in a variety of ways including dst, exp and other file organization schemes.

In the exemplary embodiment of FIG. 6, the work order instructions include image data, which depicts both the design(s) and the location(s) on the unfinished goods where the design(s) are to be placed so as to enable a user to validate the work order instructions have been accurately carried out by the machine(s) 608.

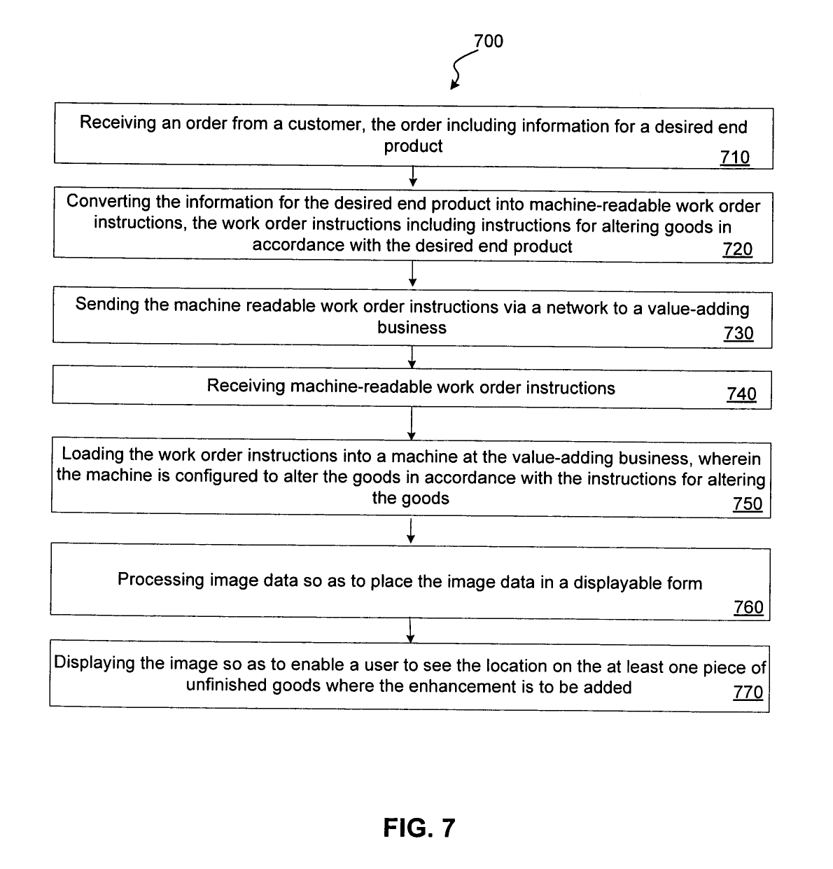

While referring to FIG. 6, simultaneous reference will be made to FIG. 7, which is a flowchart depicting a method in accordance with many embodiments of the present invention. Although the methods depicted in FIG. 7 are described with reference to FIG. 6 in order to provide specific examples of how the modules in FIG. 6 may operate, it should be recognized that the methods described with reference to FIG. 7 are certainly not limited to the specific embodiment of FIG. 6. In some embodiments for example, the methods described with reference to FIG. 7 are carried out without the server 602 depicted in FIG. 6. In variations, for example, one or more of the components depicted in the server 602 reside at the business solution center 104, 204 and work order instructions are sent directly to the machine(s) 608.

As shown in FIG. 7, when an order is received from an end customer for a desired end-product (e.g., at the business solution system 104, 204)(Block 710), it is converted into machine-readable work order instructions (e.g., the machine readable work order instructions 604), which include instructions for altering goods in accordance with the desired end product (Block 720). The work order instructions are then sent via a network (e.g., the communication network 124) to the to a value-adding business where the instructions are received and processed (Blocks 730, 740).

In the exemplary embodiment depicted in FIG. 6, for example, the business solution system interface 614 enables the server 602 to communicate with, and receive work order instructions 604 from, the business solution system 104, 204. Once received, the work order instructions 604 are retained and managed by the queue management module 618, and the work order instruction parser 624 retrieves constituent components of the work order instructions 604. In many embodiments for example, the work order instructions 604 include image data, identification data and machine-readable design data, goods information and production order requirements.

As depicted in FIG. 7, once the work order instructions are received (Block 740), and unfinished goods are available, at least a portion of the work order instructions are loaded into a machine at the value-adding business (Block 750). In the exemplary embodiment depicted in FIG. 6, suppliers of unfinished goods receive (e.g., from the business solutions system 104, 204), in connection with an order for unfinished goods, bar code data that identifies the work order instructions 604 that are sent to the value adding business 600. And in turn, the suppliers affix printed bar code data to the unfinished goods that are shipped to the value-adding business. In this way, when the unfinished goods are received and scanned by the scanner 606, the scanner module 616 decodes the bar code data to enable the unfinished goods to be associated with the correct work order instructions. A user is then able to initiate the loading of at least a portion of the work order instructions into the machine(s) 608.

Referring again to FIG. 7, in some embodiments image data from the work order instructions is processed and displayed so as to enable a user to see the location where a design is to be placed on the unfinished goods (Blocks 760, 770). As described further with reference to FIG. 8, in some embodiments the work order instructions 604 include data for many varieties of unfinished goods (e.g., different types and sizes) and different design data for each of the varieties of unfinished goods. As a consequence, in some embodiments, the work order instructions 604 include image data for several images, which may be individually selected and displayed (e.g., via the printer and/or user interface 610) for the user.

In the exemplary embodiment depicted in FIG. 6, the work order instructions, including bar code information associated with the work order instructions, may be printed by the printer 612 and scanned with the scanner 606 to load particular jobs and designs. In one embodiment, the printed work order instructions include an image of each design in connection with bar code information to enable a user to load data for a particular design into the machine(s) 608 by scanning the printed work order instructions.

In other embodiments, the work order instructions are presented to a user via the user interface and particular jobs and associated designs may be loaded by clicking hypertext that is displayed in connection with an image of the finished products. In yet other embodiments, the user may simply type in the name of the design to load data for the design into the machine(s).

Referring next to FIG. 8, shown are exemplary work order instructions 804, which may be implemented for the work order instructions 604 of FIG. 6. As shown, the work order instructions 804 in this embodiment include a work order identification portion 806 and data for N jobs. The work order identification 806 in this embodiment includes information that enables the work order instructions 804 to be identified from among other work order instructions (e.g., generated from other end customers).

In some embodiments (e.g., embodiments described with reference to FIG. 6) the work order identification information 806 includes information encoded as bar code data, but this is certainly not required and other types of identifying information may be utilized.

As shown, each of the N jobs depicted in FIG. 8, include design data for N designs, goods data and production order requirements. In this embodiment, each job is associated with a particular variety (e.g., size and/or type) of unfinished goods, and associated with each of the N designs are a design identification portion and an image portion. In many embodiments, the design identification includes bar code information and in other embodiments the design identification is hypertext data that enables design data for each of the N designs to be accessed by mouse click. In yet other embodiments, the design identification is a file name, which is associated with each design.

In many embodiments, the image data for each of the N designs includes image data for both the design and also at least a portion of the goods that the design is being incorporated into. In some embodiments for example, the image data includes data which graphically describes a location on the goods where the design is to be rendered. In this way, the image data may be utilized to confirm the finished goods have been completed as-ordered.

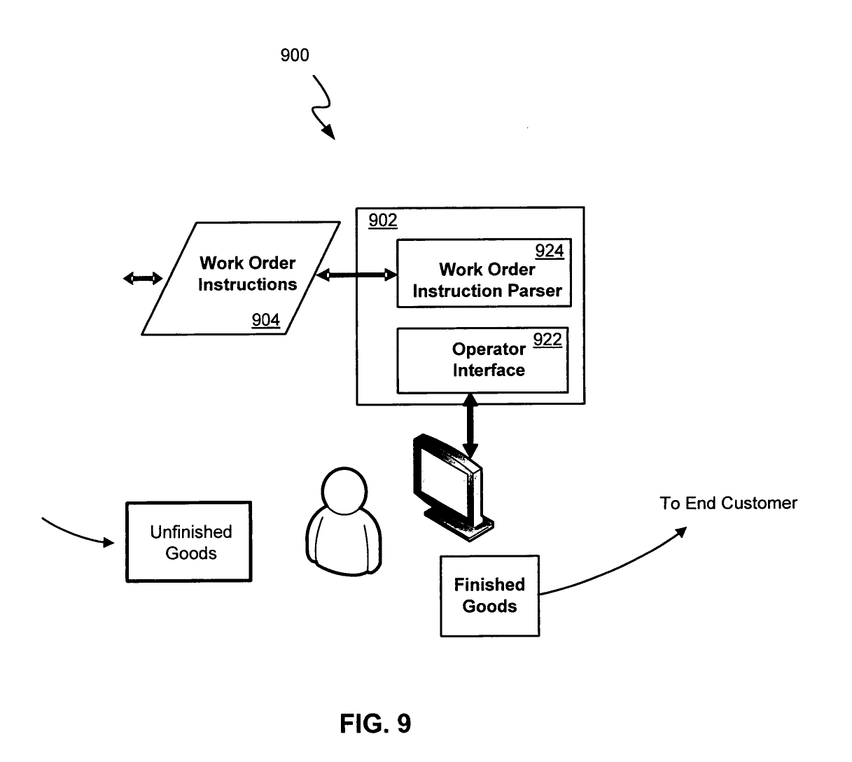

Referring next to FIG. 9, shown is a block diagram depicting an exemplary work order processing system 900. As shown, in this embodiment a work order processor 902 includes a work order parser 924, which is configured to receive and parse out image data from work order instructions 904. The image data is then presented to a user via an operator interface 922 to enable a user to see an image of what the finished goods should look like. In this way, the user is provided information to assist the user in adding enhancements to unfinished goods and to provide a mechanism for quality control so that the finished goods can be compared against the rendering of the desired finished goods.

In several embodiments, the work order parser 924 and operator interface 922 are realized by software that is executed by one or more processors, but this is not required, and in other variations the modules may be realized by hardware or a combination of hardware and software.

In conclusion, several embodiments of the present invention provide, among other things, a system and method for providing work order instructions. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A method for generating a work order comprising:
receiving an order from a customer, the order including information for a desired end product;
converting the information for the desired end product into machine-readable work order instructions, the work order instructions including instructions for altering goods in accordance with the desired end product;
sending the machine readable work order instructions via a network to a value-adding business; and
loading the work order instructions into a machine at the value-adding business, wherein the machine is configured to alter the goods in accordance with the instructions for altering the goods.

2. The method of claim 1, including sending information identifying the goods to a supplier of the goods in connection with data identifying the machine-readable work order instructions so as to enable the supplier to provide the data identifying the work order instructions to the value-adding business in connection with the goods.

3. The method of claim 2, wherein the supplier of goods provides the data identifying the work order instructions as bar code data that is affixed to shipping materials that the supplier sends with the goods so as to enable the value-adding business to scan the bar code data in order to identify the work order instructions associated with the goods.

4. The method of claim 1, wherein the goods include goods selected from the group consisting of: textiles, clothing, wood, ceramics, paper, fabrics, stone and metal.

5. The method of claim 1, wherein the converting includes creating a hyperlink in the machine readable work order instructions so as to enable the work order instructions to be effectuated by the machine in response to a user clicking on the hyperlink.

6. The method of claim 1, wherein the converting includes providing bar code information in the machine readable work order instructions so as to enable the work order instructions to be effectuated by the machine in response to a user scanning a printed version of the bar code information.

7. The method of claim 1, wherein the loading the work order instructions includes identifying a file name and manually loading the work order instructions.

8. The method of claim 1, wherein the converting includes converting the information for the desired end product into data defining a graphical representation of the end product so as to enable a user to view the desired end product.

9. The method of claim 8 including comparing the graphical representation of the end product with the goods altered by the machine so as to verify the altered goods match the desired end product.

10. The method of claim 8, including comparing the graphical representation of the end product with goods prepared for shipping so as to verify the goods prepared for shipping match the desired end product.

11. The method of claim 10 including using the a printed portion of the machine-readable work order instructions as a shipping form.

12. A machine-readable data construct for ordering work comprising:
design data that defines a design selected by an end customer, wherein the design data includes sufficient data to enable a machine configured to read the design data to alter goods so as to effectuate the design;
goods data that defines particular goods selected by the end customer that are to be altered in accordance with the design data;
graphics data including data representing the design selected by the end customer; and
design identification data including data that is utilized in connection with initiating execution of the design data by the machine.

13. The machine readable data construct of claim 12, wherein the design data, goods data and graphics data are organized into jobs wherein each job includes particular design data for a particular selection of goods, and wherein the particular design data for each job is associated with design identification data.

14. The machine readable data construct of claim 12, wherein the design identification data is a file name.

15. The machine readable data construct of claim 12, wherein the design identification data is hypertext data.

16. The machine readable data construct of claim 10, wherein the design identification data is bar code data.

17. A method for finishing goods comprising:
receiving machine-readable work order instructions, the work order instructions including machine readable instructions for altering goods in accordance with at least one design, graphical data representing the at least one design and work order identification data, wherein the work order identification data includes data to enable the machine-readable work order instructions to be identified from among other work-order instructions;
retaining the machine-readable work order instructions so as to be able to execute the machine-readable instructions for altering the goods when desired;
loading the machine-readable instructions for altering the goods into a machine that is configured to read the machine-readable instructions for altering the goods and to alter the goods in accordance with the machine-readable instructions for altering the goods.

18. The method of claim 17 including:
receiving the goods from a supplier of goods, wherein the goods are received with the work order identification data encoded as bar code data;
scanning the bar code data so as to decode the bar code data into the work order identification data; and
utilizing the work order identification data to identify the machine-readable work order instructions from among the other work-order instructions.

19. The method of claim 17, wherein the machine-readable work order instructions include design data details so as to enable a user to view the details relating to the at least one design.

20. The method of claim 17, wherein the machine readable work order instructions include design identification data for each of a plurality of designs so as to enable each of the plurality of designs to be referenced.

21. The method of claim 20, wherein the design identification data includes hyperlink data linking each of the plurality of designs with a corresponding one of a plurality of machine readable instruction sets for altering goods in accordance with each design so as to enable a particular machine readable instruction set to be effectuated by the machine in response to a user clicking on a particular hyperlink.

22. The method of claim 20, wherein the design identification data includes bar code data for each of the plurality of designs so as to enable particular machine readable instructions to be effectuated by the machine in response to a user scanning a bar code for a particular design.

23. The method of claim 20, wherein the design identification data includes a file name for each of the plurality of designs so as to enable a particular machine executable instructions to be executed by the machine in response to a user manually entering the file name into the machine.

24. A method for enhancing goods comprising:
receiving a machine-readable work order file, the work order file including information which identifies at least one enhancement that is to be added to at least one piece of unfinished goods, and wherein the work order file includes image data for an image, which depicts a location on the at least one piece of unfinished goods where the at least one enhancement is to be added;
processing the image data so as to place the image data in a displayable form; and
displaying the image so as to enable a user to see the location on the at least one piece of unfinished goods where the enhancement is to be added.

25. The method of claim 24, wherein the image data includes data for an image, which graphically depicts details of the at least one enhancement.

26. The method of claim 24, wherein the enhancement is an enhancement selected from the group consisting of an emblem, a zipper, a logo, a button, a hook-and-loop fastener and fabric.

27. The method of claim 24, wherein the receiving includes receiving the machine-readable work order file, via a network, from a remote location.

28. The method of claim 24, wherein the machine-readable work order file is generated at the same physical location where the image is displayed.
